(19) United States
(12) Patent Application Publication
(10) Pub. No.: US 2013/0061239 A1
(43) Pub. Date: Mar. 7, 2013

(54) System and Method for Operating a Processor

(71) Applicants: Elad Lahav, Waterloo (CA); Richard Bilson, Waterloo (CA)

(72) Inventors: Elad Lahav, Waterloo (CA); Richard Bilson, Waterloo (CA)

(21) Appl. No.: 13/634,230

(22) PCT Filed: May 24, 2011
(86) PCT No.: PCT/CA11/00590

§ 371 Date: Sep. 11, 2012

Related U.S. Application Data
(60) Provisional application No. 61/479,047, filed on Apr. 26, 2011.

(51) Int. Cl. G06F 9/46; G06F 9/48

(52) U.S. Cl. 718/108; 718/100

(57) ABSTRACT

A method and system are provided that determine a likelihood that at least one special purpose register (SPR) will be required during execution of a thread; after determining that the SPR is not likely required during execution of the thread, set a flag for the thread to indicate that the SPR is not required; and after determining that the SPR is likely required during execution of the thread, set the flag to indicate that the SPR is required.

This application claims priority from U.S. Provisional Patent Application No. 61/479,047 filed on Apr. 26, 2011, the contents of which are incorporated herein by reference.

### TECHNICAL FIELD

The following relates generally to systems and methods for operating a processor.

### BACKGROUND

In a computing environment, a thread is a unit of processing that is scheduled by an operating system. Multiple threads may exist inside the same process and share resources such as memory, instructions, and context, wherein context generally refers to the values that the thread or process reference at any given moment.

A kernel may be used as a bridge between applications and the processing done at the hardware level. A kernel that is responsible for switching between threads, typically saves the context of the previous thread, and restores the context of the new thread. The context values allow a thread to resume from its last point of execution and typically includes a set of processor register values at the time the thread is suspended.

Processors may include more registers than are needed in a particular thread. In such cases, the amount of data that is included in the thread's context can be much higher than would be needed if the context only included the data actually used by the thread. The amount of data stored for saving and restoring contexts on a thread switch can affect the time required to perform the switch, sometimes introducing undesirable latencies.

### BRIEF DESCRIPTION OF THE DRAWINGS

Embodiments will now be described by way of example only with reference to the appended drawings wherein:

FIG. 1 is a block diagram of an example wireless communication system.

FIG. 2 is a block diagram of an example embodiment of a mobile device.

FIG. 3 is a block diagram of an example configuration for a special purpose register (SPR) likelihood module.

FIG. 4 is a timing diagram illustrating an example thread switch and resumption.

FIG. 5 is a timing diagram illustrating another example thread switch and resumption.

FIG. 6 is a timing diagram illustrating example thread switches and resumptions prior to and subsequent to detection of an exception.

FIG. 7 is a timing diagram illustrating example thread switches and resumptions prior to and subsequent to detection of a pair of exceptions.

FIG. 8 is a flow chart illustrating an example set of computer executable instructions for setting a flag according to likelihood of using an SPR.

FIG. 9 is a flow chart illustrating an example set of computer executable instructions for thread execution according to a flag indicative of the likelihood of using an SPR.

FIG. 10 includes a pair of partial flow charts continuing from points A and B in FIG. 9.

FIG. 11 is a flow chart illustrating an example set of computer executable instructions for setting a flag indicative of the likelihood of using an SPR.

FIG. 12 is a block diagram of an example configuration for a mobile device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein. Also, the description is not to be considered as limiting the scope of the example embodiments described herein.

By determining the likelihood that special purpose registers (SPRs) are needed during a thread, and using a flag to indicate whether or not to take ownership of those SPRs, a balance between an “eager” approach, which stores and restores all registers all the time, and a “lazy” approach, that relies on detection of an exception in order to use the SPRs, can be achieved. It has been found that whether or not the eager option or the lazy option would lead to better performance can be difficult to determine, due to a dependency on workload characteristics. A workload with frequent use of the SPRs may benefit from the eager approach whereas a workload that rarely uses the SPRs may benefit from the lazy approach.

Since some processor architectures may still use SPRs in situations that they previously or normally would not, the number of types of threads which use the SPRs, and the nature of those threads may vary more than in traditional settings. For example, due to the use of vectorized operations in certain processor architectures, which use the FPU implicitly, floating point instructions in such an architecture may no longer be limited to threads that explicitly perform complex calculations, e.g., any thread copying memory may end up using the FPU registers implicitly.

The flag can therefore allow a hybrid of the lazy and eager options, wherein for threads that are expected to use SPRs, the cost of saving and restoring context for the SPRs can be incurred up front by avoiding exceptions later during execution. On the other hand, for threads that are not likely to use the SPRs, the cost of saving and restoring context for the SPRs, if necessary, can be deferred until later in the thread execution. In this way, when such threads do not require use of the SPRs, added efficiencies are achieved. Even if an exception is detected later during execution, and the SPRs are used, any saving and restoring that had occurred prior to the exception would have also benefited from such efficiencies by operating according to the lazy option for at least a portion of the thread.

It has also been recognized that, by tracking the existence of exceptions during execution of threads having the flag set to OFF for the SPRs associated with the exception, or by obtaining an instruction at some time subsequent to when the flag was set to be OFF for the SPRs, the flag can also be changed to accommodate changing environments, e.g. to subsequently be set ON.

Although the principles discussed below are applicable to any electronic communication device, examples will be provided for a mobile communication device, which is one of many types of electronic communication devices.

For clarity in the discussion below, mobile communication devices may be commonly referred to as “mobile devices” for brevity. Examples of applicable mobile devices may include, without limitation, cellular phones, smart-phones, wireless organizers, pagers, personal digital assistants, computers, laptops, handheld or other wireless communication devices, wirelessly enabled notebook computers, portable gaming devices, tablet computers, or any other portable electronic device with processing and communication capabilities.

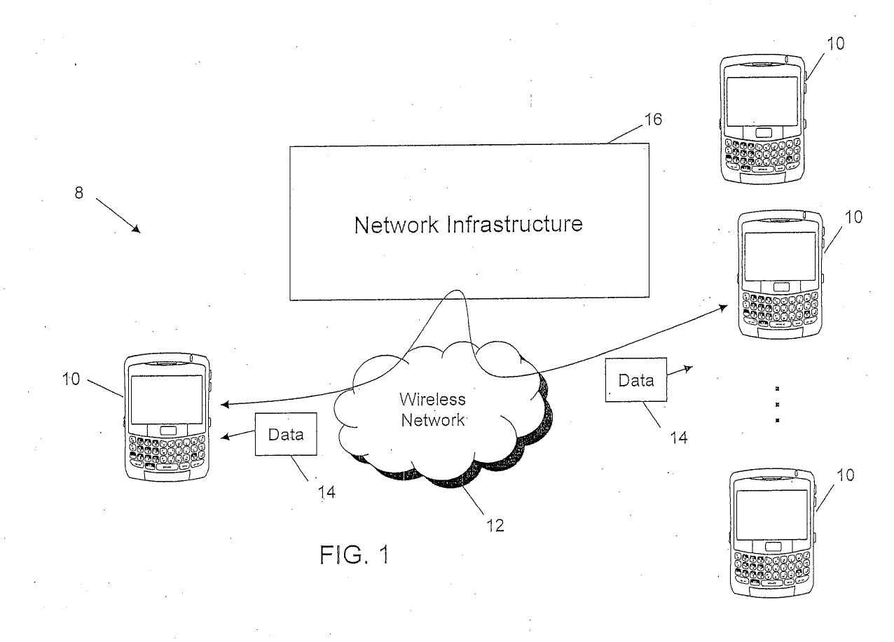

Turning to FIG. 1, an example communication system 8 is shown. The communication system 8, in this example embodiment, enables, at least in part, mobile devices 10 to communicate with each other via a wireless network 12. For example, as shown, data 14 may be exchanged between various mobile devices 10. Data 14 that is sent from one mobile device 10 to another mobile device 10 may be transmitted according to a particular messaging or communication medium, protocol, or other mechanism. For example, as shown in FIG. 1, data 14 may be sent over the wireless network 12 via a component of a network infrastructure 16. It can be appreciated that the network infrastructure 16 shown in FIG. 1 is illustrative only. The network infrastructure 16 can include various systems that may be used by the mobile devices 10 to exchange data 14. For example, a peer-to-peer (P2P) system, a short message service centre (SMSC), an email system (e.g. web-based, enterprise based, or otherwise), a web system (e.g. hosting a website or web service), a host system (e.g. enterprise server), and social networking system may be provided by or within or be otherwise supported or facilitated by the network infrastructure 16. The mobile devices 10 may therefore send data to or receive data from other mobile devices 10 via one or more particular systems with which the mobile devices 10 are communicable via the wireless network 12 and network infrastructure 16.

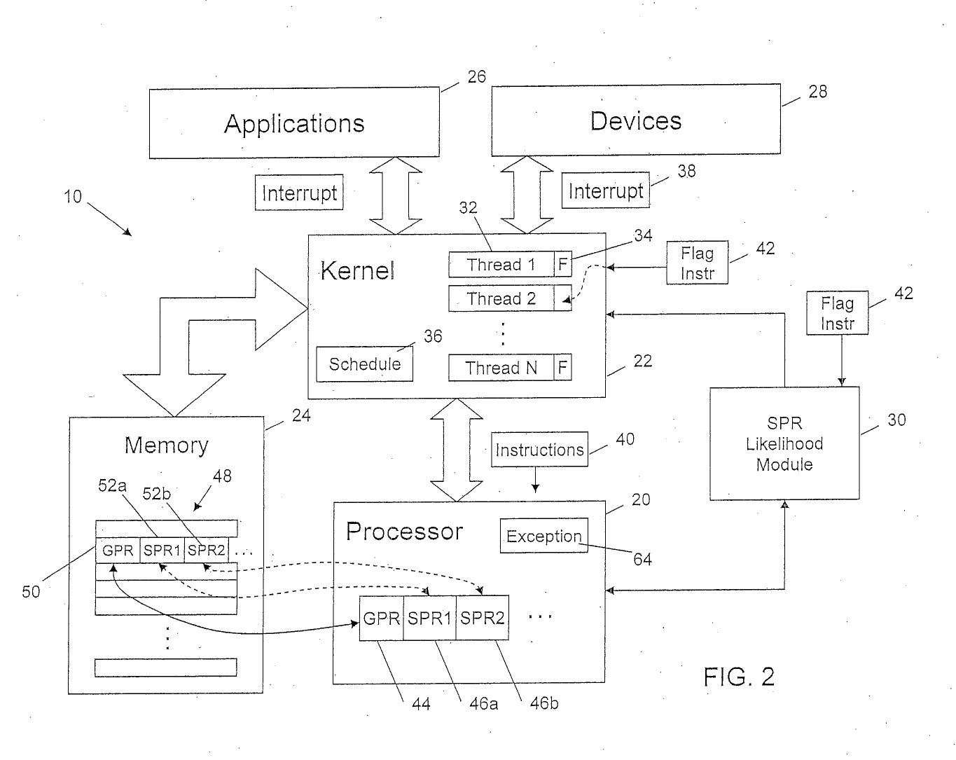

Turning now to FIG. 2, an example configuration for a mobile device 10 is shown. In this example embodiment, a processor 20 of the mobile device 10 is shown, which is, at least in part, controlled by a kernel 22. The kernel 22 provides instructions 40 to the processor 20 for scheduling one or more threads 32 according to a schedule 36. The processor 20 and the kernel 20 may, when executing the threads 32, access a memory 24. The processor 20 in this example embodiment, may execute a plurality of the threads 32 concurrently by switching therebetween, according to: the schedule 36; interrupts 38 received from or detected in association with, applications 25 or devices 28; or as a result of any other applicable criterion. For example, a lower-priority thread 32 may perform an action that unblocks a higher-priority thread 32, with the kernel 22 responding by pre-empting the former and scheduling the latter.

The processor 20 in this example embodiment, includes at least one set of general purpose registers (GPRs) 44, and at least one set of SPRs 46. In this example embodiment, two types of SPRs 46a, 46b are shown for illustrative purposes only, wherein each set of SPRs 46 may include one or more registers used for a specific purpose. The GPRs 44 include at least one register that is used for basic or routine instructions and may be used with every set of instructions 40. Each type of SPR 46 enables the processor 20 to execute specialized instructions. For example, the processor 20 may include a set of integer registers corresponding to the GPRs 44, and two sets of SPRs 46a, 46b that include a set of floating point unit (FPU) registers for executing FP operations, a set of wireless MMX (WMMX) registers for executing multimedia operations, etc. It will be appreciated that the principles discussed herein are applicable to the selective use of any one or more sets of SPRs 46, according to the likelihood that a particular thread 32 will use such SPRs 46, and the examples described herein are illustrative only.

The GPRs 44 and the one or more sets of SPRs 46 in the processor 20 are used when executing a process, and thus when switching between threads 32, the contents of the GPRs 44 and the set or sets of SPRs 46 may need to be stored in the memory 24 as the context for the previous thread 32 (i.e. the thread 32 being switched from). In the example embodiment shown in FIG. 2, the memory 24 includes a memory region 48 or other memory allocation that, in part, stores contents of the GPRs 44 and one or more sets of SPRs 46, in order to store or save a thread's context for later resumption or restoration. In this example embodiment, a segment of the memory region 48 is shown for a particular one of the threads 32, which includes a first memory allocation 50 for the GPRs 44, and one or more second memory allocations 52 for the one or more sets of SPRs 46, e.g., allocation 52a corresponding to SPR1 46a, and allocation 52b corresponding to SPR2 46b as shown in FIG. 2.

As will be discussed in greater detail below, by designating or assigning at least one flag (F) 34 to or in each thread 32, which flag 34 can be set ON or OFF (for each of one or more sets of SPRs 46), and whose state is detectable by the kernel 22, the set(s) of SPR(s) 46 can be used, or not used, during execution of that thread 32, according to the likelihood that the thread 32 will need to make use of the particular sets of SPRs 46. For example, by setting the flag 34 to ON for a particular set of SPRs 46, that thread 32 takes ownership of the corresponding SPRs 46 during execution, and saves and restores (if necessary) both the values in the GPRs 44 and those in those SPRs 46, on each thread switch. By setting the flag 34 to OFF for a particular set of SPRs 46, that thread 32 does not take ownership of the corresponding SPRs 46 during execution, and saves and restores only the values in the GPRs 44 (and other SPRs 46 if their respective flags 34 are set to ON), unless an exception 64 occurs with respect to operations requesting use of those SPRs 46. It can be appreciated that one flag 34 can be used to turn ON and OFF multiple sets of SPRs 46, or separate flags 34 can be used, each flag 34 corresponding to a particular set of SPRs 46. For example, the flag 34 shown in FIG. 2 can include one bit corresponding to each set of SPRs 46, with a zero in a bit location indicating that the corresponding SPRs 46 should be turned OFF, and a one in that bit location indicating that the corresponding SPRs 46 should be turned ON.

The flags 34 can be set for each thread 32 at the time of manufacture, during an initialization routine, or at any other suitable time subsequent thereto. For example, a flag instruction 42 can be applied or provided to the kernel 22 to have a flag 34 set for a specific thread 32 or this flag 34 can be applied or otherwise set at the time that it is scheduled by the kernel 22, or initialized on the mobile device 10. The flags 34 can also be set and/or edited by an SPR likelihood module 30. The SPR likelihood module 30 in this example embodiment can determine whether or not to set or edit a particular flag 34 according to a determination made during execution of the corresponding thread 32 by the processor 20 (e.g. detection of a particular number of exceptions 64), or by obtaining a flag instruction 42. The SPR likelihood module 30 can therefore be used to adjust the flags 34 to accommodate changes in likelihood that the thread 32 uses the corresponding SPRs 46. Such changes can be made heuristically at a higher level (e.g., within or outside of the mobile device 10), or based on at least one criterion detectable during execution of the thread 32. For example, if a flag 34 is set to off for a particular thread 32, and that thread 32 encounters exceptions 64 more than a predetermined number of times, the SPR likelihood module 30 can detect the exceptions 64, and adjust the flag setting such that the flag 34 is set to be ON thereafter.

It can be appreciated that a determination of those threads 32 which have the flag 34 set to ON for a particular set of SPRs 46, and those that have that flag 34 set to OFF, can be made according to any suitable criterion, or set of criteria, according to any suitable determined or provided heuristic data, etc. For example, if an FPU is available to the processor 20, it has been recognized that, in some example embodiments, the FPU registers are likely to be needed based on criteria such as: performance of complex calculations (e.g. graphics-oriented calculations), use of large amounts of data (e.g. copying), and user-mode threads 32 (e.g. wherein the operating system cannot tell what code will be executed). It has also been recognized that, in some example embodiments, the FPU registers are not as likely to be needed based on criteria such as: performance of primarily hardware interactions (e.g. USB), high-priority threads 32 that use short bursts of operations (e.g. timer threads, interrupt-service threads), and relatively simple code wherein it can be demonstrated that frequent access to the FPU registers is not likely required.

By determining the likelihood that the SPRs 46 are needed during the thread 32, and using a flag 34 to indicate whether or not to take ownership of those SPRs 46, a balance between an “eager” approach, which stores and restores all registers all the time, and a “lazy” approach that relies on detection of an exception 64 in order to use the SPRs 46, can be achieved. As discussed above, it has been found that whether or not the eager option or the lazy option would lead to better performance can be difficult to determine, due to a dependency on workload characteristics. A workload with frequent use of the SPRs 46 may benefit from the eager approach whereas a workload that rarely uses the SPRs 46 may benefit from the lazy approach.

Moreover, since some processor architectures may use the SPRs 46 in situations that they previously or normally would not, the number of types of threads 32 which use the SPRs 46, and the nature of those threads 32 may vary more than in traditional settings. For example, due to the use of vectorized operations in certain processor architectures, which use the FPU implicitly, floating point instructions in such an architecture may no longer be limited to threads 32 that explicitly perform complex calculations, e.g., any thread 32 copying memory may end up using the FPU registers implicitly.

The flag 34 can therefore allow a hybrid of the lazy and eager options, wherein for threads 32 that are expected to use the SPRs 46, the cost of saving and restoring context for the SPRs 46 can be incurred up front by avoiding exceptions 64 later during execution. On the other had, for threads 32 that are not likely to use the SPRs 46, the cost of saving and restoring context for the SPRs 46, if necessary, can be deferred until later in the thread execution. In this way, when such threads 32 do not require use of the SPRs 46, added efficiencies are achieved. Even if an exception 64 is detected later during execution, and the SPRs 46 are used, any saving and restoring that had occurred prior to the exception 64 would have also benefited from such efficiencies by operating according to the lazy option for at least a portion of the thread 32.

By tracking the existence of exceptions 64 during executions of the threads 32 which have the flag 34 set to OFF for the SPRs 46 associated with the exception 64, or by obtaining an instruction at some time subsequent to when the flag 34 was set to be OFF for the SPRs 46, the flag 34 can also be changed to accommodate changing environments, e.g. to subsequently be set ON. For example, a thread 32 that originally, or at some other time, had a low likelihood of requiring the SPRs 46 and thus the flag 34 for those SPRs 46 was set to OFF, but either by detecting exceptions 64 during executions of that thread 32 or otherwise determining or being instructed that the likelihood of using the SPRs 46 has increased (such that the flag 34 should instead be set to be ON), the flag 34 can be modified to accommodate the apparent change in conditions for that thread 32.

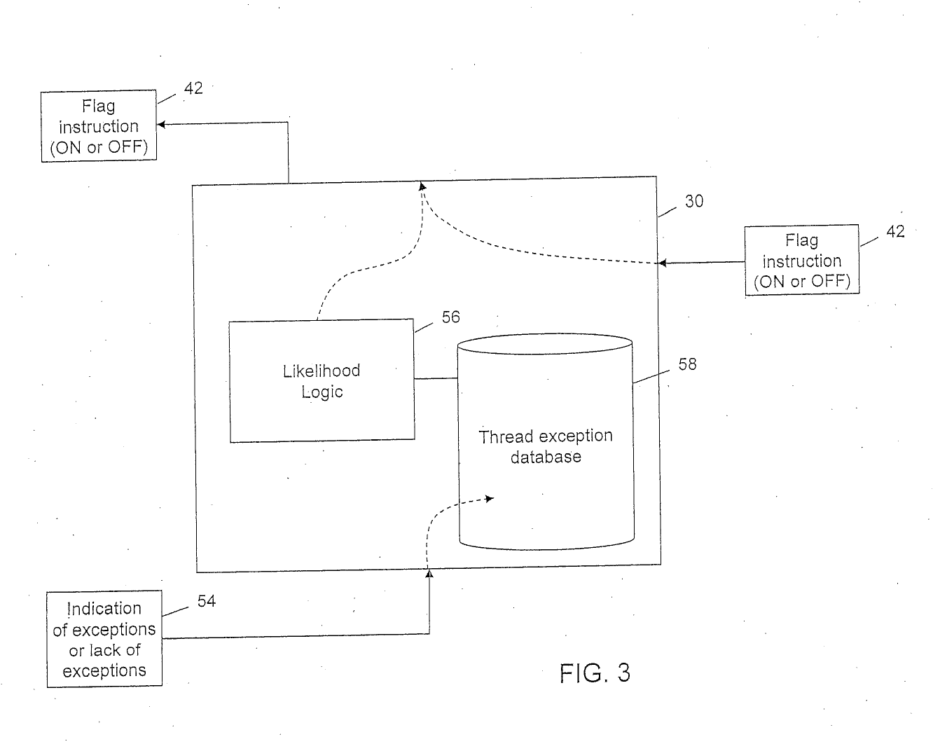

An example of an SPR likelihood module 30 configured to be operable to update the flag 34 is shown in FIG. 3. In this example embodiment, the SPR likelihood module 30 is operable to either: determine, according to likelihood logic 56, that the likelihood of use of one or more sets of SPRs 46 has changed; or to be instructed by another source or entity, that the likelihood of use of one or more of those sets of SPRs 46 has changed.

To detect that the likelihood has changed, indications 54 of exceptions 64 or lack of exceptions 64 can be determined, either by tracking such information or having such information provided to the SPR likelihood module 30. The indications 54 may then be stored and accumulated in a thread exception database 58. For example, the likelihood logic 56 can compare an accumulated number of exceptions for a particular thread 32 (in relation to a particular set of SPRs 46), and, if such a number meets a predetermined threshold (e.g. reaches or exceeds a predetermined number of exceptions), a flag instruction 42 to turn the flag 340N for a particular set of SPRs 46 when executing that thread 32 can be sent to the kernel 22. On the other hand, a flag instruction 42, based on heuristics (e.g. from an external source), may indicate that the likelihood of that thread 32 using a particular set of SPRs 46 has decreased (which would otherwise be undetectable if the flag 34 is set to be ON). If the likelihood has decreased such that at least one predetermined criterion has been met (e.g. zero exceptions 64 have been detected in a similar thread in last one hundred executions), the flag instruction 42 to turn the flag 34 OFF for a particular SPR 46 for that thread 32 can be sent to the kernel 22.

It can be appreciated that various other modules or components of the mobile device 10 may also be capable of tracking exceptions 64 in a similar way. Moreover, heuristic data determined external to the mobile device 10 may also become available and be used to update the mobile device 10 (e.g. during a software install or upgrade). In such scenarios, the flag instruction 42 can be provided either directly to the kernel 22 (as shown in FIG. 2), or via the SPR likelihood module 30 as shown in FIG. 3, e.g., rather than utilizing likelihood logic 56 and a thread exception database 58.

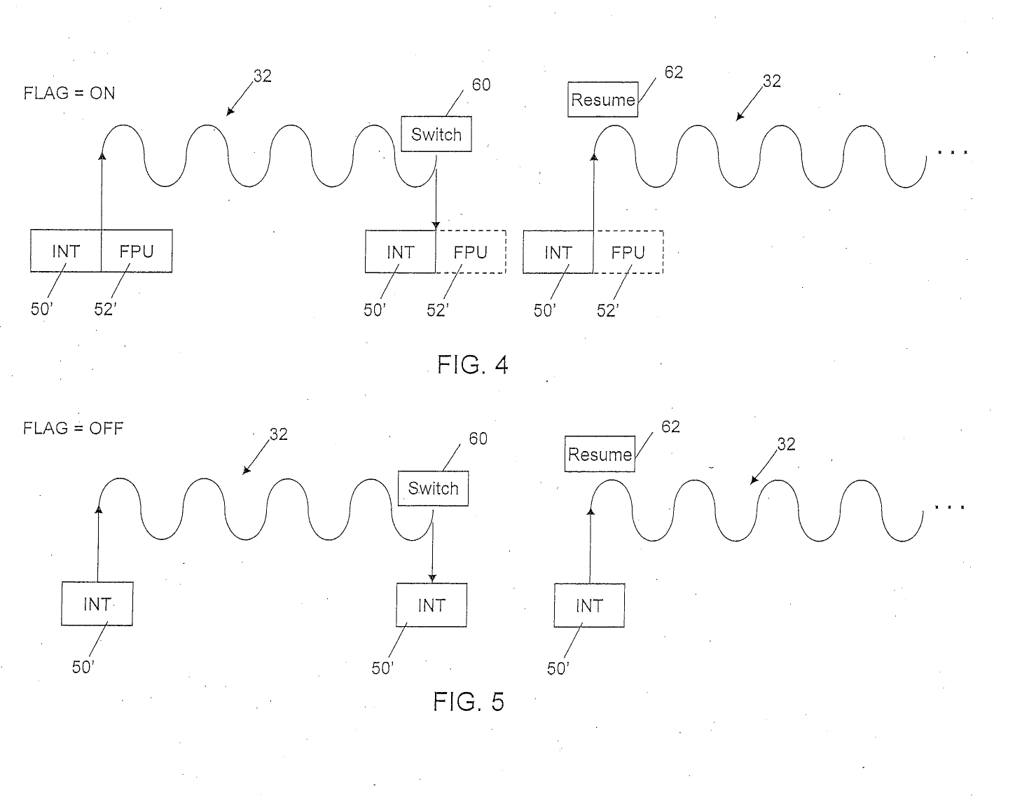

An example thread execution is illustrated in FIG. 4, in which the flag 34 for using a set of FPU SPRs 46 has been set to be ON. In the example embodiment shown, values from both the INT allocation 50′ and the FPU allocation 52′ are, if necessary, obtained from memory 24, or initiated if the thread 32 is beginning, and the context based on these values is stored in the INT GPRs 44 and the FPU SPRs 46 in the processor 20 during execution of the thread 32. In other words, the thread 32 assumes ownership of both the INT GPRs 44 and the FPU SPRs 46 in the processor 20. At a particular point in the execution, a switch 60 occurs (e.g. scheduled switch, priority scheduling, interrupt, etc.). Since the flag 34 is ON, the context for that thread 32 (to enable later resumption after switching back thereto) is stored in memory 24 using the INT allocation 50′ and, if necessary, the FPU allocation 52′. It can be appreciated that the FPU SPRs 46 are typically stored to the FPU allocation 52′ only if and when another thread 32 requires the FPU. This may occur immediately if the next thread 32 has an FPU flag 34 set to be ON, later during the switch if another thread 32 requires the FPU before resuming the thread 32 that previously assumed ownership of the FPU SPRs 46, or never if no other concurrently running thread 32 requires the FPU SPRs 46 before execution resumes in that thread 32. After resuming the thread at 62, the values from the INT allocation 50′ are obtained from memory 24 and restored to the INT registers in the processor 20 and if a thread 32 which was being executed during the switch and prior to the resumption took ownership of the FPU, the values from the FPU allocation 52′ are also restored. Since other threads 32 may not require the FPU, and can have a flag 34 set to be OFF, the values in the FPU registers may be the same as those left behind at the point of the switch 60. In other words, if the one or more threads 32 executed at least in part during the context switch did not take ownership of the SPRs 46, the thread 32 would still own the SPRs 46 and thus would not need to save or restore the values from memory 24. Therefore, since the flags 34 can be used to control ownership of the SPRs 46, the flag 34 enables not only efficiencies intra-thread, but also inter-thread.

FIG. 5 illustrates another example thread 32, for which the flag 34 associated with the FPU is set to be OFF. It can be seen in FIG. 5 that since no exceptions are encountered during the portions of the thread 32 shown, the context switching involves only the saving and restoring of the values in the INT allocation 50′.

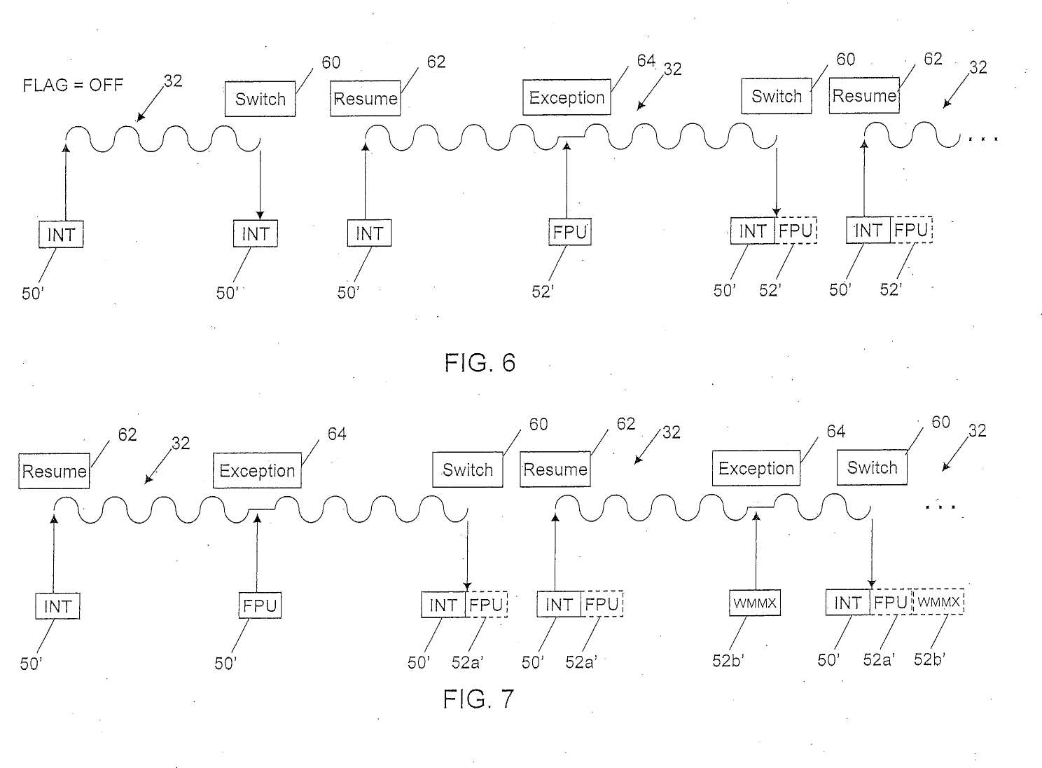

FIG. 6 illustrates a thread 32 that begins in the same way as the thread 32 in FIG. 5, but encounters an exception 64 emanating from an attempt to access the SPRs 46, subsequent to the first resume 62 seen in the diagram. In this example embodiment, it can be appreciated that after encountering the exception 64, the current values in the SPRs 46 are saved for the current owner of the SPRs 46 (e.g. another thread 32 that has been previously switched out), and the thread 32 takes ownership of the set of FPU SPRs 46, in order to enable the FPU instructions to be executed. At the next context switch 60 in the thread 32, the values in the INT GPRs 44 are saved to the allocation 50′ in memory 24 and if there is a change in ownership of the FPU, the values in the FPU SPRs 46 are stored to the FPU allocation 52′ in memory 24. After resuming at 62, the values in the INT allocation 50′ and if necessary, the values in the FPU allocation 52′ are restored as described above.

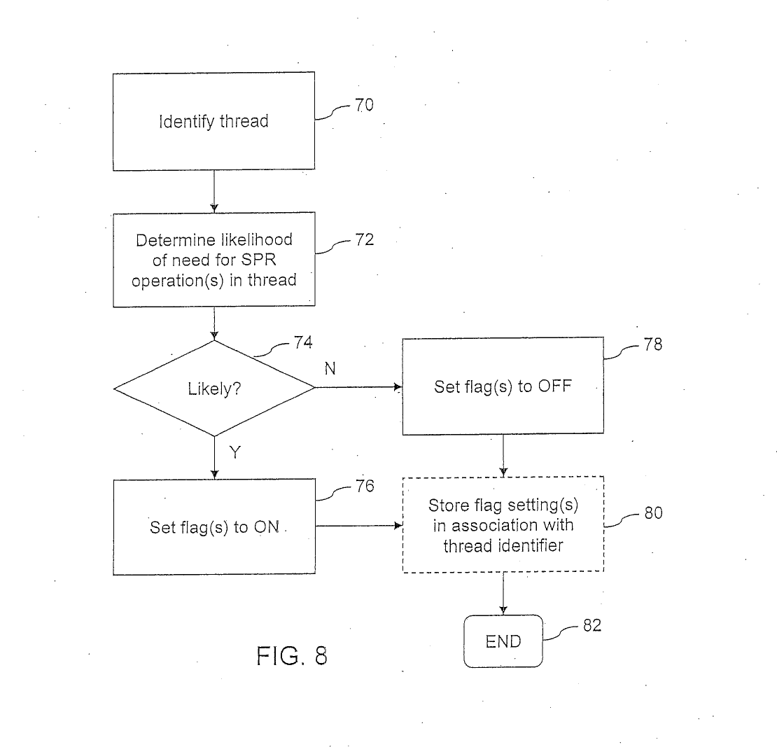

FIG. 7 illustrates a thread 32 that encounters a pair of exceptions 64 during the portion of the thread 32 shown in the diagram. At the first exception 64, FPU instructions are to be executed and thus the current values in the SPRs 46 are saved for the current owner of the SPRs 46, and ownership of a first set of SPRs 46a (corresponding to the FPU registers in this example) taken as described above with respect to FIG. 6. In this example embodiment, a second set of SPRs 46b corresponding to WMMX instructions is also requested, causing a second exception 64. The second exception 64 causes ownership of the second set of SPRs 46b to be assumed and subsequent context switching in the thread 32 to include, if necessary, storage of the values from the FPU allocation 52a′ and/or values from the WMMX allocation 52b′, in addition to values from the INT allocation 50′.

FIG. 8 illustrates an example set of computer executable operations that may be performed in setting flags 34 for threads 32 according to the likelihood that such threads 32 need to use one or more sets of SPRs 46. It can be appreciated that the operations shown in FIG. 8 can be executed at any suitable time, for example, at the time of manufacture of the mobile device 10, at the time of programming or compiling software to be installed or otherwise executed on the mobile device 10, at the time of installing or upgrading software on the mobile device 10, etc. In this example embodiment, the thread 32 for which the flag 34 is to be set is identified at 70, and the likelihood of the need for one or more types of SPR operations or instructions in that thread 32 is determined at 72. For each type of SPRs 46 being evaluated, it is determined at 74 if that type of SPR 46 is likely to be used during execution of the thread 32 identified at 70. If that type of SPR 46 is likely to be used (e.g. use of FPU registers likely due to the presence of complex calculations), the corresponding flag 46 is set to be ON at 76. If that type of SPR 46 is not likely to be used during execution of the thread 32 (e.g. WMMX registers not likely required due to lack of multimedia component to the thread 32), the corresponding flag 46 is set to be OFF at 78. The flag 46, set to be ON or OFF at either 76 or 78 respectively, may then, optionally, be stored in association with an identifier for that thread 32. For example, a list of threads 32 and their respective flag settings may be stored in the thread exception database 58 or elsewhere for later reference. It can be appreciated that the flag settings may instead be referenced directly from the thread 32 itself, in which case the flag settings may not need to be stored elsewhere. Once the flag(s) 34 has/have been set at 76 and/or 78, the process ends at 82.

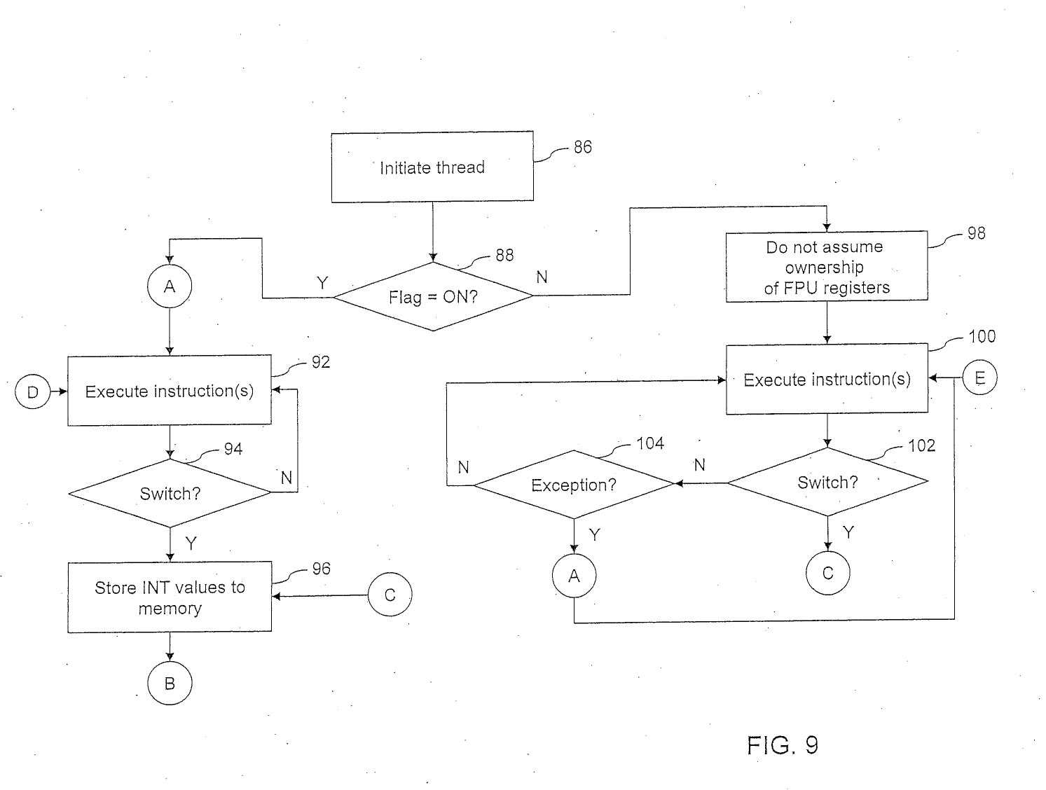

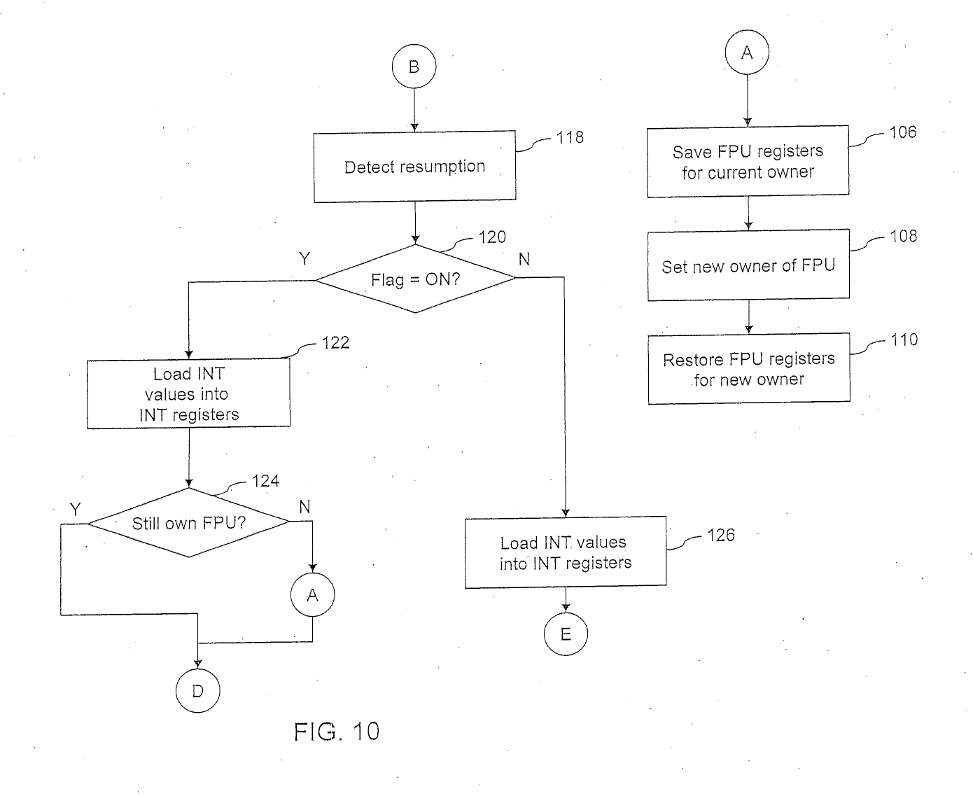

FIG. 9 illustrates an example set of computer executable operations that may be performed in executing an example thread 32. It can be appreciated that although this example embodiment illustrates a flag 34 associated with use of FPU registers, the same principles apply to the use, or lack of use, of any one or more sets of SPRs 46. In this example embodiment, the thread 32 is initiated at 86 and whether or not the FPU flag 34 is set to ON is determined at 88. If the flag 34 is set to ON, the thread 32 takes ownership of the FPU SPRs 46 by proceeding to A (in FIG. 10). In order to take ownership of the FPU SPRs 46, the FPU SPRs 46 are saved for the current owner at 106 (e.g. a previous thread 32 which has switched to the thread 32 initiated at 86), the new thread 32 is set as the owner of the FPU SPRs 46 at 108, and the values from the FPU allocation 52′ in memory are restored to the FPU SPRs 46 at 110.

After taking ownership of the FPU SPRs 46, execution proceeds as shown in FIG. 9, and one or more instructions are executed at 92. During execution, the processor 20 determines, at 94, whether or not a switch 60 is encountered, e.g. due to scheduling, detected interrupt, etc. If not, the thread's instructions may continue to be executed at 92, e.g. until complete, or until detecting a switch 60 at 94. After detecting a switch 60 at 94, the context is saved by storing the values in the INT GPRs 44 to the INT allocation 50′ at 96 and execution proceeds to B in FIG. 10, to be discussed further below.

If at 88, it is determined that the flag 34 is set to OFF, ownership of the FPU is not assumed at 98, and thread instructions 40 are executed at 100. It can be appreciated that operation 98 is shown for ease of illustration and to not assume ownership may include taking no action in that regard. During execution, the processor 20 determines, at 102, whether or not a switch 60 is encountered, e.g. due to scheduling, detecting an interrupt, etc. If not, it is determined whether or not an exception 64 has been encountered at 104. If neither a switch 60 nor an exception 64 is encountered, the thread's instructions 40 may continue to be executed at 100. After detecting a switch 60 at 102, the INT portion of the context is saved by proceeding to C (in FIG. 9) to operation 96 In this example embodiment, if an exception is detected at 106, ownership of the FPU is assumed by proceeding to A (in FIG. 10) as discussed above, such that FPU instructions may be executed at 100.

Turning now to FIG. 10, thread execution continues from B in FIG. 9. Starting at B in FIG. 10, after detecting a resumption of the thread 32 at 118, the kernel 22 determines at 120 whether or not the flag 34 is set to be ON or OFF. If the flag 34 is ON, the values in the INT allocation 50′ are restored to the INT GPRs 44 at 122, and the kernel 22 determines at 124 whether or not the thread 32 still owns the FPU SPRs 46. If the thread 32 does still own the FPU SPRs 46, the values in the FPU SPRs 46 would already correspond to the FPU portion of the thread context and thus only the values from the INT allocation 50′ need to be loaded into the INT GPRs 44 and execution of the thread 32 may then continue by proceeding to D (in FIG. 9). If the thread 32 does not still own the FPU SPRs 46, both the INT and FPU values would be loaded from memory 24 by additionally proceeding to A (in FIG. 10) in order to assume ownership of the FPU as discussed above. Execution of the thread 32 may then continue by proceeding to D (in FIG. 9).

If at 120 the kernel 22 determines that the flag 34 is OFF, the values from the INT allocation 50′ are loaded into the INT GPRs 44 at 126. Execution of the thread 32 may then continue by proceeding to E (in FIG. 9).

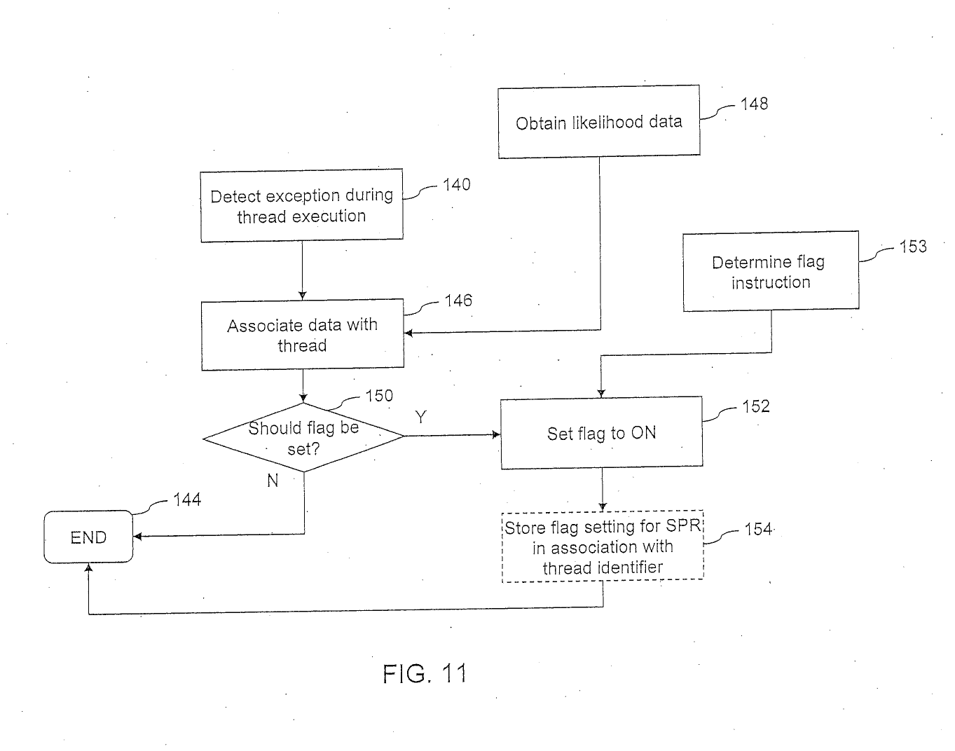

FIG. 11 illustrates an example set of computer executable operations that may be performed in updating a flag 34. In this example embodiment, the flag 34 is currently OFF, and may be updated according to any one or more of: events detected by the SPR likelihood module 30, likelihood data or flag instructions 42 obtained by the SPR likelihood module 30 (or kernel 22). It can be appreciated that if the flag 34 is set to ON, the corresponding SPRs 46 are running and thus no exceptions 64 are expected In this example embodiment, an exception 64 is detected during thread execution at 140. An indication or tally of the exception 64 may be stored or otherwise associated with the thread 32 at 146, e.g. by storing such an indication in the thread exception database 58. In another example, likelihood data (e.g. heuristic data or other information indicative of an increased likelihood) may be obtained at 148 and associated with the thread at 146. The data associated with the thread 32 at 146 may then be used at 150 to determine whether or not the flag should be set to ON. If not, the process ends at 144. If the data associated with the thread 32 indicates that the flag 34 should be turned ON, the flag 34 is set to be ON at 152. In another example, a flag instruction 42 may be determined at 153, indicating that the flag 34 should be changed to be ON. The flag setting for the corresponding SPRs 46 may then optionally be stored in association with a thread identifier at 154, e.g. in the thread exception database 58 or elsewhere as discussed above.

It can be appreciated that similar logic, with operation 152 being applied in reverse (i.e. OFF instead of ON), can be used to determine whether or not to set a flag 34, that is currently ON, to be OFF. For example, as discussed above, a flag instruction 46, based on heuristics (e.g. from an external source), may indicate that the likelihood of that thread 32 using a particular set of SPRs 46 has decreased (which would otherwise be undetectable if the flag 34 is set to be ON). In such an example scenario, the flag 34 can be set to be OFF such that use of the SPRs 46 only occurs after detecting an exception emanating from a request to use same.

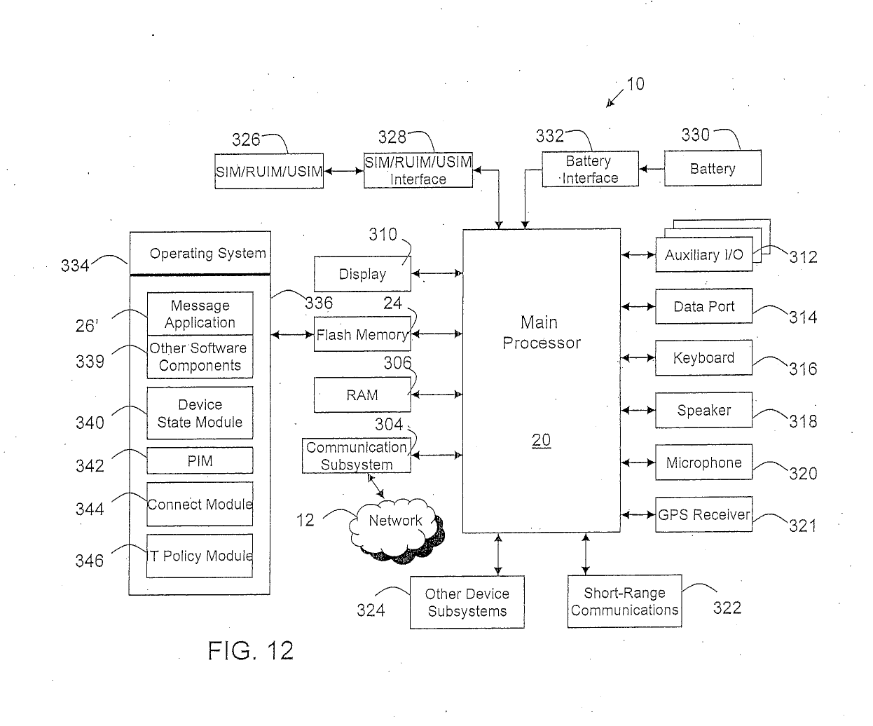

Referring now to FIG. 12, shown therein is a block diagram of an example embodiment of a mobile device 10. The mobile device 10 comprises a number of components such as a main processor 20 that controls the overall operation of the mobile device 10. Communication functions, including data and voice communications, are performed through a communication subsystem 304. The communication subsystem 304 receives messages from and sends messages to a wireless network 12. In this example embodiment of the mobile device 10, the communication subsystem 304 is configured in accordance with the Global System for Mobile Communication (GSM) and General Packet Radio Services (GPRS) standards. The GSM/GPRS wireless network is used worldwide and it is expected that these standards will be superseded eventually by 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the embodiments described herein are intended to use any other suitable standards that are developed in the future. The wireless link connecting the communication subsystem 304 with the wireless network 12 represents one or more different Radio Frequency (RF) channels, operating according to defined protocols specified for GSM/GPRS communications. With newer network protocols, these channels are capable of supporting both circuit switched voice communications and packet switched data communications.

The main processor 20 also interacts with additional subsystems such as a Random Access Memory (RAM) 306, a flash memory 24, a display 310, an auxiliary input/output (I/O) subsystem 312, a data port 314, a keyboard 316, a speaker 318, a microphone 320, GPS receiver 321, short-range communications 322 and other device subsystems 324.

Some of the subsystems of the mobile device 10 perform communication-related functions, whereas other subsystems may provide “resident” or on-device functions. By way of example, the display 310 and the keyboard 316 may be used for both communication-related functions, such as entering a text message for transmission over the network 12, and device-resident functions such as a calculator or task list.

The mobile device 10 can send and receive communication signals over the wireless network 12 after required network registration or activation procedures have been completed. Network access is associated with a subscriber or user of the mobile device 10. To identify a subscriber, the mobile device 10 may use a subscriber module. Examples of such subscriber modules include a Subscriber Identity Module (SIM) developed for GSM networks, a Removable User Identity Module (RUIM) developed for CDMA networks and a Universal Subscriber Identity Module (USIM) developed for 3G networks such as UMTS. In the example shown, a SIM/RUIM/USIM 326 is to be inserted into a SIM/RUIM/USIM interface 328 in order to communicate with a network. The SIM/RUIM/USIM component 326 is one type of a conventional “smart card” that can be used to identify a subscriber of the mobile device 10 and to personalize the mobile device 10, among other things. Without the component 326, the mobile device 10 may not be fully operational for communication with the wireless network 12. By inserting the SIM/RUIM/USIM 326 into the SIM/RUIM/USIM interface 328, a subscriber can access all subscribed services. Services may include: web browsing and messaging such as e-mail, voice mail, SMS, and MMS. More advanced services may include: point of sale, field service and sales force automation. The SIM/RUIM/USIM 326 includes a processor and memory for storing information. Once the SIM/RUIM/USIM 326 is inserted into the SIM/RUIM/USIM interface 328, it is coupled to the main processor 20. In order to identify the subscriber, the SIM/RUIM/USIM 326 can include some user parameters such as an International Mobile Subscriber Identity (IMSI). An advantage of using the SIM/RUIM/USIM 326 is that a subscriber is not necessarily bound by any single physical mobile device. The SIM/RUIM/USIM 326 may store additional subscriber information for a mobile device as well, including datebook (or calendar) information and recent call information. Alternatively, user identification information can also be programmed into the flash memory 24.

The mobile device 10 is typically a battery-powered device and includes a battery interface 332 for receiving one or more batteries 330 (typically rechargeable). In at least some embodiments, the battery 330 can be a smart battery with an embedded microprocessor. The battery interface 332 is coupled to a regulator (not shown), which assists the battery 330 in providing power V+ to the mobile device 10. Although current technology makes use of a battery, future technologies such as micro fuel cells may provide the power to the mobile device 10.

The mobile device 10 also includes an operating system 334 and software components 336 to 346 which are described in more detail below. The operating system 334 and the software components 336 to 346 that are executed by the main processor 20 are typically stored in a persistent store such as the flash memory 24, which may alternatively be a read-only memory (ROM) or similar storage element (not shown). Those skilled in the art will appreciate that portions of the operating system 334 and the software components 336 to 346, such as specific device applications, or parts thereof, may be temporarily loaded into a volatile store such as the RAM 306. Other software components can also be included, as is well known to those skilled in the art.

The subset of software applications 336 that control basic device operations, including data and voice communication applications, may be installed on the mobile device 10 during its manufacture. Other software applications include a message application 26′ that can be any suitable software program that allows a user of the mobile device 10 to send and receive electronic messages. Various alternatives exist for the message application 26′ as is well known to those skilled in the art. Messages that have been sent or received by the user are typically stored in the flash memory 24 of the mobile device 10 or some other suitable storage element in the mobile device 10. In at least some embodiments, some of the sent and received messages may be stored remotely from the mobile device 10 such as in a data store of an associated host system that the mobile device 10 communicates with.

The software applications can further comprise a device state module 340, a Personal Information Manager (PIM) 342, and other suitable modules (not shown). The device state module 340 provides persistence, i.e. the device state module 340 ensures that important device data is stored in persistent memory, such as the flash memory 24, so that the data is not lost when the mobile device 10 is turned off or loses power.

The PIM 342 includes functionality for organizing and managing data items of interest to the user, such as, but not limited to, e-mail, contacts, calendar events, voice mails, appointments, and task items. A PIM application has the ability to send and receive data items via the wireless network 12. PIM data items may be seamlessly integrated, synchronized, and updated via the wireless network 12 with the mobile device subscriber's corresponding data items stored and/or associated with a host computer system. This functionality creates a mirrored host computer on the mobile device 10 with respect to such items. This can be particularly advantageous when the host computer system is the mobile device subscriber's office computer system.

The mobile device 10 may also comprise a connect module 344, and an IT policy module 346. The connect module 344 implements the communication protocols that are required for the mobile device 10 to communicate with the wireless infrastructure and any host system, such as an enterprise system, that the mobile device 10 is authorized to interface with.

The connect module 344 includes a set of APIs that can be integrated with the mobile device 10 to allow the mobile device 10 to use any number of services associated with the enterprise system. The connect module 344 allows the mobile device 10 to establish an end-to-end secure, authenticated communication pipe with a host system (not shown). A subset of applications for which access is provided by the connect module 344 can be used to pass IT policy commands from the host system to the mobile device 10. This can be done in a wireless or wired manner. These instructions can then be passed to the IT policy module 346 to modify the configuration of the device 10. Alternatively, in some cases, the IT policy update can also be done over a wired connection.

The IT policy module 346 receives IT policy data that encodes the IT policy. The IT policy module 346 then ensures that the IT policy data is authenticated by the mobile device 10. The IT policy data can then be stored in the flash memory 306 in its native form. After the IT policy data is stored, a global notification can be sent by the IT policy module 346 to all of the applications residing on the mobile device 10. Applications for which the IT policy may be applicable then respond by reading the IT policy data to look for IT policy rules that are applicable.

Other types of software applications or components 339 can also be installed on the mobile device 10. These software applications 339 can be pre-installed applications (i.e. other than message application 26′) or third party applications, which are added after the manufacture of the mobile device 10. Examples of third party applications include games, calculators, utilities, etc.

The additional applications 339 can be loaded onto the mobile device 10 through at least one of the wireless network 12, the auxiliary I/O subsystem 312, the data port 314, the short-range communications subsystem 322, or any other suitable device subsystem 324. This flexibility in application installation increases the functionality of the mobile device 10 and may provide enhanced on-device functions, communication-related functions, or both. For example, secure communication applications may enable electronic commerce functions and other such financial transactions to be performed using the mobile device 10.

The data port 314 enables a subscriber to set preferences through an external device or software application and extends the capabilities of the mobile device 10 by providing for information or software downloads to the mobile device 10 other than through a wireless communication network. The alternate download path may, for example, be used to load an encryption key onto the mobile device 10 through a direct and thus reliable and trusted connection to provide secure device communication.

The data port 314 can be any suitable port that enables data communication between the mobile device 10 and another computing device. The data port 314 can be a serial or a parallel port. In some instances, the data port 314 can be a USB port that includes data lines for data transfer and a supply line that can provide a charging current to charge the battery 330 of the mobile device 10.

The short-range communications subsystem 322 provides for communication between the mobile device 10 and different systems or devices, without the use of the wireless network 12. For example, the subsystem 322 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download may be processed by the communication subsystem 304 and input to the main processor 20. The main processor 20 may then process the received signal for output to the display 310 or alternatively to the auxiliary I/O subsystem 312. A subscriber may also compose data items, such as e-mail messages, for example, using the keyboard 316 in conjunction with the display 310 and possibly the auxiliary I/O subsystem 312. The auxiliary subsystem 312 may comprise devices such as: a touch screen, mouse, track ball, infrared fingerprint detector, or a roller wheel with dynamic button pressing capability. The keyboard 316 is an alphanumeric keyboard and/or telephone-type keypad. However, other types of keyboards may also be used, such as a virtual or “soft” keyboard rendered as images on a touch screen. A composed item may be transmitted over the wireless network 12 through the communication subsystem 304.

For voice communications, the overall operation of the mobile device 10 in this example is substantially similar, except that the received signals are output to the speaker 318, and signals for transmission are generated by the microphone 320. Alternative voice or audio I/O subsystems, such as a voice message recording subsystem, can also be implemented on the mobile device 10. Although voice or audio signal output is accomplished primarily through the speaker 318, the display 310 can also be used to provide additional information such as the identity of a calling party, duration of a voice call, or other voice call related information.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, any component of or related to the wireless infrastructure 16, etc., or accessible or connectable thereto. Any application or module herein described may be implemented using computer readable/executable instructions that may be stored or otherwise held by such computer readable media.

It will also be appreciated that the example embodiments and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method comprising:
prior to execution of a thread, determining a likelihood that at least one special purpose register (SPR) will be required during execution of the thread;
after determining that the SPR is not likely required during execution of the thread, setting a flag for the thread to indicate that the SPR is not required; and
after determining that the SPR is likely required during execution of the thread, setting the flag to indicate that the SPR is required.

2. The method according to claim 1, further comprising storing the flag setting in association with an identifier for the thread.

3. The method according to claim 1, further comprising:
determining that the flag setting should be changed; and
changing the flag setting according to the determining.

4. The method according to claim 3, wherein after determining that a first predetermined number of exceptions have been encountered during a second predetermined number of executions of the thread, and the flag setting indicates that the SPR is not likely to be used, the flag setting is changed to indicate that SPR is required.

5. The method according to claim 3, wherein the determining comprises receiving an instruction indicating that the SPR is not as likely to be used, and the method further comprising changing the flag setting to indicate that the SPR is not required.

6. The method according to claim 1, further comprising detecting initiation of the thread, detecting a switch to another thread, and storing values from at least one general purpose register (GPR).

7. The method according to claim 6, further comprising:
detecting resumption of the thread;
loading stored values into the GPR;
determining if the thread still owns the SPR;
if the thread still owns the SPR, continuing execution of the thread using values remaining in the SPR; and
if the thread does not still own the SPR, saving values in the SPR for a current owner, setting the thread as a new owner of the SPR, and loading stored values into the SPR.

8. The method according to claim 1, further comprising detecting initiation of the thread, detecting an exception during execution of the thread, saving values in the SPR for a current owner, setting the thread as a new owner of the SPR, and loading stored values into the SPR.

9. The method according to claim 8, further comprising detecting a switch to another thread, and storing values from at least one general purpose register (GPR).

10. The method according to claim 9, further comprising:
detecting resumption of the thread;
loading stored values into the GPR;
determining if the thread still owns the SPR;
if the thread still owns the SPR, continuing execution of the thread using values remaining in the SPR; and
if the thread does not still own the SPR, saving values in the SPR for a current owner, setting the thread as a new owner of the SPR, and loading stored values into the SPR.

11. A computer readable medium comprising computer executable instructions for operating a processor, the computer executable instructions comprising instructions for performing the method according to claim 1.

12. A computing device comprising a processor and memory, the memory comprising computer executable instructions for performing the method according to claim 1.

13. The computing device according to claim 12, wherein the computing device comprises communications capabilities.

14. A mobile device comprising the computing device of claim 12.
